(19) United States
(12) Patent Application Publication
(10) Pub. No.: US 2011/0146880 A1
(43) Pub. Date: Jun. 23, 2011

(54) METHOD AND DEVICE FOR EQUIPPING CONTAINERS

(75) Inventors: Klaus Krämer, Dortmund (DE); Thomas Stienen, Unna (DE)

(73) Assignee: KHS GmbH, Dortmund (DE)

(21) Appl. No.: 13/054,890

(22) PCT Filed: Oct. 8, 2009
(86) PCT No.: PCT/EP09/07209

§ 371 Date: Feb. 25, 2011

(30) Foreign Application Priority Data
Oct. 17, 2008 (DE) 10 2008 051 791.7

(51) Int. Cl. B32B 37/02; B31B 1/00; B41F 17/00; B41F 33/00

(52) U.S. Cl. 156/64; 493/52; 156/378; 101/35; 101/483

(57) ABSTRACT

The invention relates to a method for equipping containers (2) with equipping features (3), the containers (2), which are situated on at least one transport element (4) of a transport section (7, 4, 12), being moved past at least one processing station (8-12) of an equipping system (20) in order for each container (2) to be supplied with at least one equipping feature (3), characterized in that the actual geometry or shape of the container (2) is detected at least in areas that are relevant for equipping, and the equipping process is then adapted by controlling and/or regulating and/or adjusting the equipping system (20) and/or the location and/or orientation of the container (2) to the detected actual geometry or shape of the container (2).

The invention concerns a method according to the preamble of claim 1 and a device according to the preamble of claim 12.

Methods and devices for equipping bottles or suchlike containers, i.e. for application of equipping elements on containers, are known in a variety of designs. Also especially well known are methods and devices for labelling bottles or suchlike containers, the corresponding devices in that case being designed, for example, as labelling machines for processing single-sheet labels, sleeve labels, self-adhesive labels or roll-fed labels.

Also known are devices for equipping containers by imprinting, for example using label-like printed images, including the use of electrically-controllable printing heads, e.g. operating according to the inkjet or Tonejet principle, which are driven by an electronic controller (e.g. computer) using digital artwork masters stored therein.

All methods and devices or machines in common use until now for equipping bottles or other containers require that the processed bottles or containers, at least on the areas of their outer container surfaces relevant for equipping purposes, i.e. on those areas on which the equipping features are to be applied and/or generated, have a true geometry or shape defined i.a. by their dimensions (actual geometry or shape) which corresponds as exactly as possible to a set geometry or shape, or at least deviates from this by an extremely small amount.

Permissible tolerances, for example in the container diameter, for the ordinary diameter of the bottles used in the beverage industry lie in the range of +/−1.5 mm or for example in an angular deviation of the container's axis from the perpendicular line with respect to the bottle base in the range of a maximum of 0.3°, etc.

The increasing pressure of competition, including internationally, is forcing many businesses in the beverage industry to take advantage of any cost-saving potential which may arise, in order to be able to continue offering products at competitive prices. This results, i.a., in the fact that packaging materials and in particular the containers or bottles normally used to hold beverages, must be purchased as cheaply and economically as possible. In many cases, this means that the actual geometry and shape or the actual size of the containers, in particular in the areas relevant for equipping purposes, deviates far more than previously permissible from the specified or desired set geometry or shape or the specified or desired set dimensions, i.e. the corresponding tolerances are substantially greater than the tolerances which are permitted for the formerly common methods and devices for correct and optically flawless equipping. This leads to a deterioration in the quality of labelling and, in a plurality of labelled containers, to a very noticeable impairment of the optical appearance of the equipping.

Deviations of the respective container geometry or shape which exceed the permissible tolerance limit lead, namely, in the known methods and devices, i.a. to the fact that equipping elements and/or labels do not have the necessary location and orientation in relation to typical and conspicuous container features, for example in relation to the container axis, e.g. are oriented at an angle to the container axis and/or, where there are several equipping elements or labels provided on each container, these are not provided in the desired and necessary relationship to each other, but are offset from each other, so that an unacceptable, optically unattractive appearance results for the container equipping, and this (appearance) inevitably communicates to the consumer the impression of a lesser quality of the product and therefore has an adverse effect on the buying decision.

A solution to this problem is not yet known.

In order to protect labelling machines from impairments or even damage, former practice has frequently been to check the containers, prior to labelling, by means of simple methods, for example light barriers, for compliance with certain height dimensions and then to separate out or transfer out any containers that are either too large or too small.

In other cases the containers are examined following labelling for compliance with target set points with respect to the labelling or equipping quality and, where there are clearly perceptible deviations from these target set points, separated out. This is disadvantageous i.a. because these known methods significantly reduce the output of an entire plant (number of labelled containers leaving the entire plant per unit of time) and the containers transferred out give rise to additional costs, at least due to a cost-intensive reworking or retouching.

Also known are methods in which labels or other equipping elements are applied as exactly as possible to container areas dictated by the shape of the containers, for example within frame-type or indented container areas or, again, in container areas characterised by a spatial relation to a particular shape, e.g. seal marks. In these methods, an opto-electrical capture takes place, followed by alignment of the respective container in such a way that the respective equipping element is applied in the desired way, in a precise relationship to the respective container area. These known methods and devices, however, also require that the actual geometry or shape of the containers, at least in the areas relevant for equipping purposes, i.e. where equipping elements are to be applied, corresponds very precisely to the set geometry or shape. Deviations or tolerances are therefore only permitted within the very narrow tolerance range.

A device and a method concerning this type of labelling were proposed by DE 10 2006 026 618 A1. This document deals with the labelling of containers which have a container feature, for example a seal mark, and whereby a label is intended to be applied to the container in precise alignment to this container feature. To this end, DE 10 2006 026 618 A1 proposes that, in a first alignment step, the container should be only roughly aligned, and in a second step the precise size and also the precise location of the container feature are determined. Next, the label—avoiding any fresh alignment of the container—is applied to the container by precise control of the time of transfer of the label onto the container in especially precise alignment to the container feature. The disadvantage of this device is that it only demonstrates a way to improve the application accuracy of labels, but provides no indication as to the processing of containers with greater dimensional deviations or dimensional variations.

The problem of the invention is to demonstrate a method which avoids these disadvantages and makes it possible also to provide those containers whose actual geometry or shape deviates significantly from the set geometry or shape with an optically attractive equipping.

To solve this problem, a method according to claim 1 has been devised. A device to carry out the method is the subject matter of claim 2^{1.} ¹ Translator's note: this should be claims 12.

According to the invention, the application of the equipping to the container takes place using an equipping system which has at least one processing station, with which the respective equipping element is applied to the containers, for example in the form of a label or an imprint. The processing station is then for example a labelling device for processing single-sheet labels, sleeve labels, self-adhesive labels or roll-fed labels, or again, at least one printing station with at least one printing head, preferably with an electrically-controlled printing head, e.g. with a printing head which works according to the inkjet or Tonejet principle, a printed image in each case being generated by an electronic controller, for example using digital artwork masters stored in a computer.

Contrary to known methods, it is possible with the invention to process even less-dimensionally-correct containers, i.e. to process containers which deviate significantly even in their areas relevant for equipping purposes from the set geometry or shape or the set dimensions, in such a way that good, or at least still-usable equipping results are achieved.

The invention is based on the finding that although containers with a true geometry or shape (actual geometry or shape) which significantly deviates from a set geometry or shape do favour the occurrence of equipping errors, the frequency and the degree of severity of such equipping errors can be greatly reduced by appropriate countermeasures.

To this end, the invention makes general provision for the fact that at least some of the containers to be provided with the respective equipping can be captured prior to application of the equipping, at least in partial areas, and at the same time in particular in the areas relevant for equipping purposes, with respect to their actual geometry or shape or the corresponding dimensions, and then, as a function of this actual geometry or shape or of data obtained herefrom, for example also by comparison with a set geometry or shape, the equipping process is adapted in such a way that, even where there is an actual geometry or shape which lies clearly outside a formerly permissible tolerance range, it is still possible to achieve at least a usable equipping result.

The adaptation occurs in this case by corresponding alignment of the containers during the equipping process, i.e. for example when applying the respective label and/or printed image, and/or by corresponding control of the equipping system applying and/or generating the equipping elements, for example by activating in each case at least one processing station of several processing stations forming the equipping system, which is assigned to the respective actual geometry or shape and/or the respective deviation of the actual geometry or shape of a container from a set geometry or shape and is optimally adjusted and/or operated for this actual geometry or shape.

The equipping system can also be adapted to the actual geometry or shape of a container by a corresponding actual adjustment of one or more processing stations and/or of the working method of these work stations. When using at least one electronically-controlled printing head, there is the option of adapting the equipping process to the true actual geometry or shape of the containers by corresponding modification or adaptation of the digital artwork masters, for example by compression, rotation or stretching, etc.

The basis of all optimisation methods according to the invention is that the containers to be provided with the equipping are captured, prior to the application of the equipping, in suitable fashion with respect to their actual geometry or shape at least in the respective areas relevant for equipping purposes. This occurs, for example, by the fact that the actual dimensions of the containers are determined at least in the respective area relevant for equipping purposes. But it may also be sufficient in this case merely to determine the dimensional or deviational range in which the actual dimensions of a container lie, at least in the area(s) relevant for equipping purposes, so that there is no need to determine the precise actual dimensions of the respective container.

The capture of the actual geometry or shape of the containers occurs, for example, within the machine or device used to apply the equipping, for example within the labelling machine, e.g. after the containers have been slid onto a rotor or onto container carriers thereon, or rotary tables of the processing positions on the rotor, and/or outside the rotor or the machine or device, for example in a separate machine preceding the equipping machine or on an external transporter for feeding the containers to the equipping machine or in the area of a container intake of the equipping machine, e.g. on a star-shaped feed device of a container intake etc.

The capture of the actual geometry or shape of the containers can e.g. occur using any appropriate technique known to the person skilled in the art, for example, but not limited to, the use of laser beam sampling or scanning, by capture with at least one camera, for example digital camera followed by computer-aided image processing, by light barriers, ultrasound, in particular by ultrasound range-finding etc.

Refinements, advantages and possible applications of the invention will become apparent from the following description of embodiments and from the figures. In the following, all features described and/or illustrated, either per se or in any combination, are in principle the subject matter of the invention, regardless of their summary in the claims or back-references thereto. The content of the claims is also an integral part of the description.

The invention is next explained in more detail on the basis of the figures of embodiments, which show:

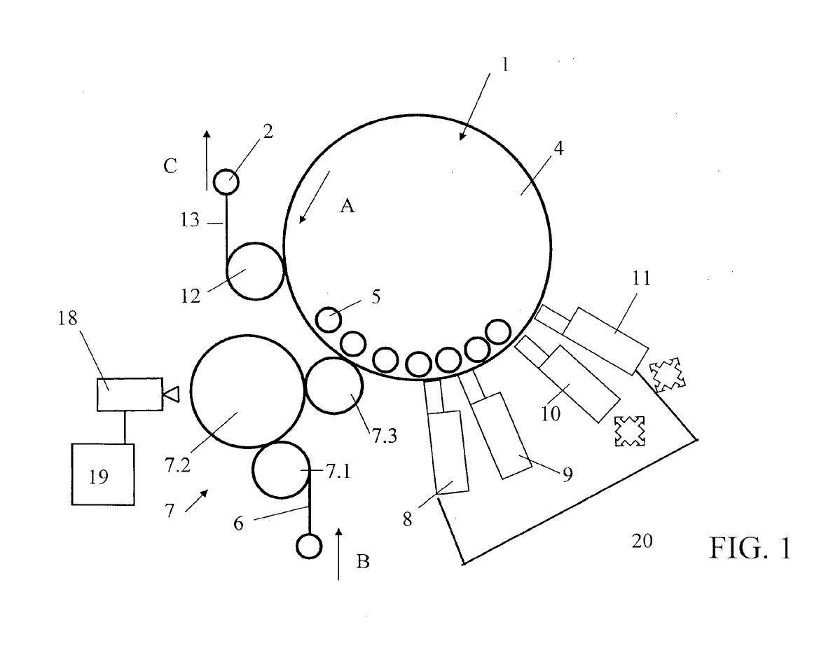

FIG. 1 in highly diagrammatic form, a machine for equipping containers in the form of bottles, designed as a labelling machine;

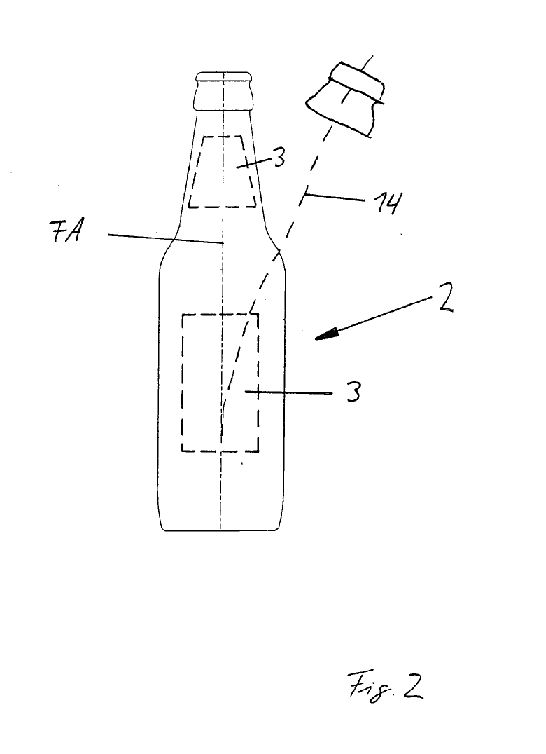

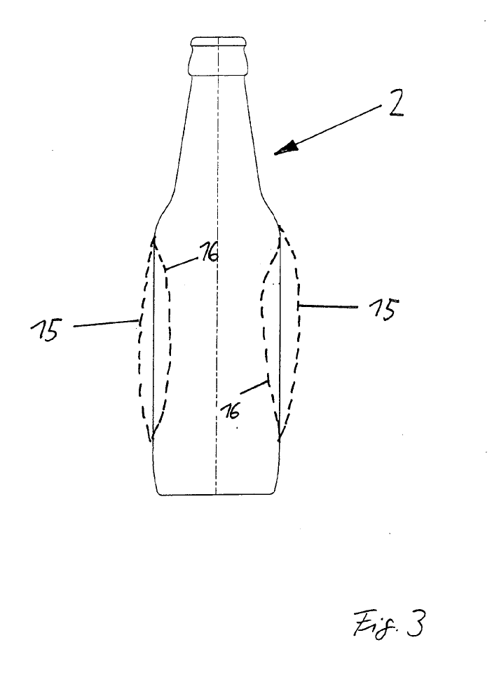

FIGS. 2 and 3 each show, in lateral view, bottles with different deviations from the set geometry or shape, at least in the area of the bottles or containers relevant for equipping purposes;

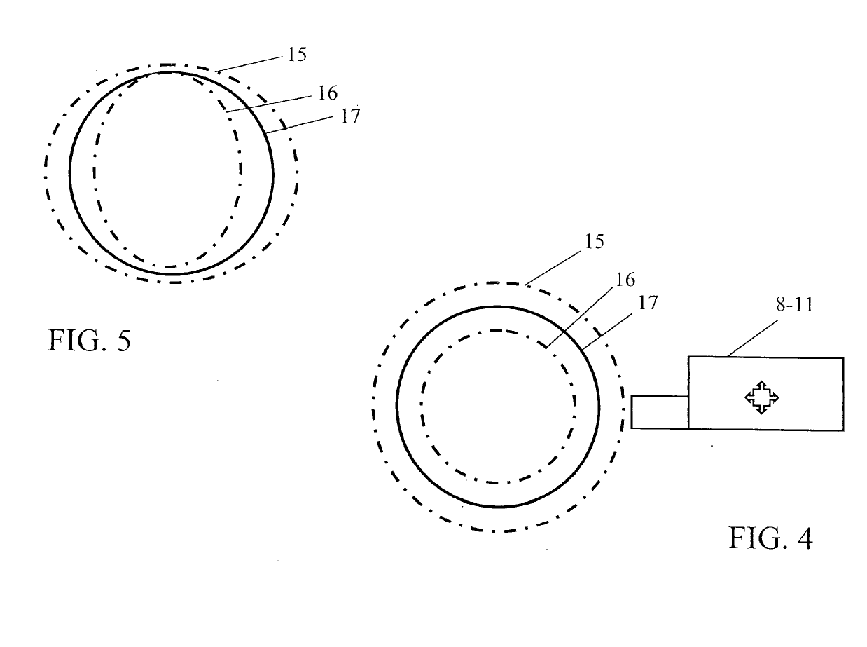

FIGS. 4 and 5 each show, in diagram view and in horizontal projection, the circumferential area with various deviations from the set geometry.

In the figures, 1 is a labelling machine for labelling containers in the form of bottles 2 with at least one label 3 each, but preferably with several labels 3 each, in the form of a body label, a shoulder label and a back label. The bottles 2 are for example made from glass or plastic.

The labelling machine 1 comprises, in known fashion, a rotor 4 driven in rotation about a vertical machine axis in the direction of the arrow A, on the periphery of which several processing positions 5 are formed, with container carriers in the form of controlled rotary tables. The bottles 2 to be labelled are fed to the labelling machine 1 standing upright via an external transporter 6 in the direction of transport B and go firstly to a container intake 7, which in the embodiment shown is formed from three transport star wheels 7.1-7.2 adjoining each other in the direction of transport. Each bottle 2 is passed on from the container intake 7, or from the transport star wheel 7.3 there, to a processing position 5, on whose container carrier, still standing upright, i.e. with its bottle axis oriented in the horizontal² direction, it is moved past various labelling devices 8-11, which are provided on the movement path of the processing positions 5 so as not to move with the rotor 4, for the labels 3 to be applied in the way described in more detail below. ² Translator's note: “in horizontaler Richtung” must be incorrect and should presumably read “in vertikaler Richtung.” In FIG. 2, the bottle axis (FA) is vertical.

The bottles 2 provided with the labels 3 are removed from the processing positions 5 at a container outlet 12, formed, in the embodiment shown, from a transport star wheel, and passed on to an external transporter 13, via which the labelled bottles 2 are fed, in the direction of arrow C, for further use, for example to a machine for packaging.

The requirement for the respective equipping comprised by the labels 3 to be correctly applied to the bottles 2, i.e. that the labels 3 are in the desired location and orientation in relation to typical features of the bottles 2, e.g. in relation to the bottle axis FA, and, in the case of several labels 3 on each bottle 2, also relative to each other, i.e. erroneous equippings are avoided, would in the first instance be that the external geometry or shape of each bottle 2, at least in the area relevant for equipping purposes, onto which the respective label 3 should be applied, corresponds as exactly as possible to a set geometry or shape, or at least with minor deviations which lie within a very narrow range of tolerance.

Especially in the case of cheaply produced bottles 2, this condition cannot, however, be met, in fact bottles 2 of this type, especially in the areas of the external surface of the bottles relevant for equipping purposes, sometimes have quite substantial deviations from the set geometry or shape or the corresponding set dimensions, so that ordinary methods necessarily lead to high error rates in the labelling of containers of this type.

Merely by way of explanation and of example, but by no means limitatively, FIGS. 2-5 show various deviations from the set geometry or shape, in particular of the area of the external surface of the bottles relevant for equipping purposes. So, for example, the bottle axis FA may be bent, and/or have an inclination of less than 90° relative to the bottle base, as shown in exaggerated fashion in FIG. 2 with the broken line 14.

FIG. 3 shows a bottle 2, which in the body area, i.e. in the area there which is relevant for equipping purposes, at least on part of its circumference, has a convexity, indicated in this figure with the broken line 15, and/or a narrowing, indicated by the broken line 16 and therefore, in the area of the external surface relevant for equipping purposes, a significant deviation from the set geometry or shape.

FIG. 4 shows in horizontal projection with the circle 17 the circular cylindrical external surface of a bottle 2, which (external surface) corresponds to the set geometry or shape. The broken lines 15 and 16 again designate the convexity or narrowing, which extends in each case over the entire perimeter of the bottle 2 and again represents a significant deviation from the set geometry or shape in the area relevant for equipping purposes, i.e. in the body area.

As indicated in FIG. 5 by the broken lines 15 and 16, these deviations from the set geometry or shape, again indicated by the circle 17, at the area relevant for equipping purposes, can also, on a partial area of the height and/or of the perimeter of the bottle 2, be in the form of a convexity (broken line 15) and on a part of the height and/or of the perimeter of the bottle 2 as a narrowing (broken line 16) etc.

In order nevertheless to attain a still-acceptable equipping, despite these or other deviations which the external surface of the bottle exhibits, at least in the respective area relevant for equipping purposes, the equipping process and/or labelling carried out by the labelling machine 1 takes place by taking into account the respective actual geometry or actual geometry or shape, which the bottles 2 have, at least in the area relevant for equipping purposes. To this end, in the embodiment shown, an opto-electrical sensor device 18 in the form of at least one camera is provided at the container intake 7, i.e. on the transport star wheel 7.2 there, with which the actual geometry or shape of each bottle 2, at least at the respective area relevant for equipping purposes, is captured. The sensor device 18 co-operates with a computer-aided image processing and control system 19, to which the data (image data) supplied by the sensor unit 18 is fed and in which this data is compared with the respective data corresponding to the set geometry.

The equipping or labelling system 20 formed by the labelling devices 8-11 is then controlled by the image processing and control system 19 in such a way that the respective label 3 is applied to the bottle 2 concerned in a way which is adapted to the actual geometry or shape, e.g. the actual deformation of the respective area relevant for equipping purposes, so that despite any deviation of the area relevant for equipping purposes from the set geometry or shape, an optically (still) attractive equipping or labelling of the bottle 2 concerned is achieved.

Preferably, the image processing and control system 19 also effects a control of the processing positions 5 or container carriers thereon such that an alignment of the respective bottle 2 or its orientation e.g. by pivoting and/or rotation about at least one spatial axis takes place in order to compensate for the respective deviation of the actual geometry or shape from the set geometry.

In detail, the control of the labelling system 20 in order to compensate or to reduce the effect of deviations in the bottle geometry on the equipping result can take place such that for typical actual geometries or shapes or actual dimensions, which the bottles 2 each display on an outer area relevant for equipping purposes, thus both for the actual geometries corresponding to the respective set geometry, as well as for significant deviations from the set geometry, groups can be formed, and at least one labelling device 8-11 is assigned to each group, said device being adapted or adjusted to the typical actual geometry or shape for the corresponding group in order to achieve the most exact and flawless labelling possible.

Using the data captured by the sensor unit 18, the bottles 2 are then each assigned, according to their actual geometry, to one of these groups and the application of the label 3 then takes place using the labelling device 8-11 assigned to this group. If the labelling of the bottles 2 takes place in such a way that at least two labels 3 are to be applied to each bottle 2 in different areas, then, for example, on the basis of the data supplied by the sensor unit 18, each area of each bottle 2 relevant for equipping purposes will be grouped into the associated group on the basis of its actual geometry, and in turn for the application of the label 3 using the labelling device 8-11 associated with this group. Additionally, there is in turn an alignment of the bottles 2 at the container positions 5 as a function of the data supplied by the sensor unit 18.

The group division can also take place according to different tolerance ranges, such that the labelling devices 8-11 or groups of at least two labelling devices 8-11 are each assigned a tolerance range for the deviation between the actual geometry or shape and the set geometry or shape, so that for each bottle 2 the deviation of the actual geometry or shape from the set geometry or shape, at least at the area relevant for equipping purposes, is determined and then the labelling process takes place with that labelling device 8-11 which is assigned to the tolerance range corresponding to the determined deviation.

There is also the option of designing at least some of the labelling devices 8-11 in such a way that their working method and/or setting and/or orientation are controlled in real time by the image processing and control system 19, as a function of the container data captured using the sensor unit 18 and/or as a function of control data obtained herefrom, in particular taking account of deviation from the set geometry, such that despite deviations of the areas relevant for equipping purposes from the set geometry, a still-attractive equipping or labelling of the bottles 2 is achieved. To this end, the labelling devices 8-11 of the labelling system 20 are, for example, organised such that some of these devices, for example the first two labelling devices 8 and 9, are provided for the labelling of bottles 2, in which deviations from the set geometry in the areas relevant for equipping purposes are absent or else lie within a permissible range of tolerance. The other labelling devices 10 and 11 are then controlled or regulated with respect to their working method and/or location and/or orientation as a function of deviations from the set geometry. Especially where the labelling machine 1 has a high output, it is then advantageous to provide at least two labelling devices 10 and 11 which can be adjusted in this way, or else groups of such labelling devices, in sequence in the direction of rotation of the rotor 4, said devices being operated and adjusted at different times, i.e. the setting of the labelling device(s) of one group takes place during the operation of one or more of the other labelling device(s) in the other group.

The adjustment of the labelling devices for adaptation to the deviations of the bottles 2 from the set geometry takes place, for example, by feeding or removal radially to the axis of the rotor 4, in order to take account of narrowings or convexities on areas relevant for equipping purposes and/or by angling or pivoting the respective labelling device, for example to take into account inclinations of the bottle axis FA etc.

The invention has been described above on the basis of embodiments. It goes without saying that numerous modifications and changes are possible, without departing from the basic concept of the invention.

So it has been assumed in the foregoing that the equipping of the bottles 2 takes place by labelling, i.e. by applying labels 3. Obviously other methods are possible for equipping the bottles 2, for example by imprinting equipping features directly onto the external surface of the bottles or on labels already applied thereto, e.g. with only a partial equipping.

In the case of an equipping process by imprinting, instead of labelling stations 8-11, several printing heads or printing stations are provided in sequence in the direction of rotation A of the rotor 4 to form a printing or equipping system 20. These printing stations are then controlled and/or adjusted in the same way as described above for the labelling devices 8-11, as a function of the data determined by the sensor unit 18.

It also goes without saying that the invention is not restricted to the equipping of bottles 2, but can also be used for the equipping of containers in general, in particular also for containers made from glass, metal or plastic.

It also goes without saying that the invention also extends to such especially advantageous embodiments in which the determination of the container features takes place before labelling, in particular before the container is fed into the labelling machine.

### LIST OF REFERENCE NUMBERS

1 Labelling machine
2 Bottle or container
3 Label or equipping element
4 Rotor
5 Processing position
6 External transporter
7 Container intake
7.1-7.3 Transport star wheel
8-11 Labelling or equipping device
12 Container outlet
13 External transporter
14 Inclined bottle axis FA
15, 16 Deviation from the set geometry
17 Circular peripheral surface of the set geometry
18 Sensor unit
19 Image processing and control system
20 Labelling system
A Direction of rotation of rotor 4
B, C Direction of transport of the transporter 6 and 13
FA Container axis or bottle axis

1. A method for equipping containers with equipping features, the containers, which are situated on at least one transport element of a transport section being moved past at least one processing station of an equipping system in order for each container to be supplied with at least one equipping feature, said method comprising:
capturing the actual geometry or shape of the containers, at least in areas thereon that are relevant for equipping, and
adapting the equipping process to the actual geometry or shape of the containers by controlling and/or regulating and/or adjusting the equipping system and/or the location and/or orientation of the containers.

2. The method according to claim 1, wherein capturing the actual geometry or shape of the containers at least in areas thereon that are relevant for equipping comprises
capturing with at least one sensor unit, the sensor unit being disposed such that the container arrives at the sensor unit prior to entering the equipping system, and
controlling the equipping process based at least in part on data from the sensor unit.

3. The method according to claim 1, further comprising generating control data to control the equipping process by comparing the captured actual geometry or shape with a set geometry or shape.

4. The method according to claim 1,
further comprising assigning the respective actual geometry or shape of the containers, at least in areas thereon that are relevant for equipping, to groups of container geometries or tolerance groups, and
wherein adapting the equipping process takes place during the equipping process according to a program specified for the respective group.

5. The method according to claim 4, wherein the equipping system has several processing stations, at least one of which is assigned to each group, and wherein adapting the equipping process to the actual geometry or shape takes place at the at least one processing station assigned to an actual geometry or shape group.

6. The method according to claim 1, wherein adapting the equipping process to the actual geometry or shape comprises
changing the working method by altering the setting and/or the orientation of the at least one processing station in relation to the containers moved past the at least one processing station.

7. The method according to claim 6, wherein the equipping system has at least two processing stations, and wherein operation of the processing stations in the application of the respective equipping element to the containers and adapting the equipping process to the actual geometry or shape take place at different times at different processing stations.

8. The method of claim 1, wherein when there are several equipping elements to be applied to each container, capturing comprises capturing the actual geometry or shape of each area of each container relevant for equipping and, for each equipping element, adapting the equipping process comprises adapting to the respective actual geometry or shape of the area relevant for equipping which is assigned to the equipping element.

9. The method of claim 1, further comprising:
using a transport system formed, at least partially, by a rotor driven in rotation about a vertical machine axis, with which the containers are moved past on the equipping system which does not move together with the rotor, and
wherein capturing the actual geometry or shape of the containers on areas thereon that are relevant for equipping takes place on the rotor or on a transport element preceding the rotor in the direction of transport of the transport system.

10. The method of claim 1, wherein equipping containers comprises applying labels, and wherein the at least one processing station of the equipping system is a labelling device.

11. The method of claim 1, wherein the actual the set geometry or shape of the containers, at least in the areas thereon that are relevant for equipping purposes, is a form that is rotationally symmetrical in relation to a container axis.

12. A device for equipping containers with equipping features, said device comprising:
at least one transport section;
at least one processing station of an equipping system provided on the transport section past which the containers are moved in order to apply at least one equipping feature;
on the transport section, means for capturing the actual geometry or shape of the containers at least in areas thereon that are relevant for equipping purposes; and
means for adapting the equipping system and/or the location and/or orientation of the containers to the captured actual geometry or shape of the respective container.

13. The device according to claim 12,
wherein the means for capturing comprises at least one sensor unit for capturing the actual geometry or shape,
wherein said sensor section is arranged on the transport section such that the container arrives at the sensor unit prior to entering the equipping system, and
wherein the means for adapting comprises a control system for controlling the equipping process taking into account data from the sensor unit.

14. The device according to claim 13, wherein the control system is configured to generate control data to control the equipping process by comparing the captured actual geometry or shape with a set geometry or shape.

15. The device according to claim 12, wherein the at least one some-ewe processing stations are designed is configured to change at least one of a working method, a setting, and an orientation as a function of the actual geometry or shape.

16. The device according to claim 13,
wherein the transport section is partly formed by a rotor driven in rotation about a vertical machine axis, with which the containers are moved past the equipping system which does not move together with the rotor, and
wherein the sensor unit is provided on the rotor or on a transport element preceding the rotor in the direction of transport of the transport systems.

17. The device according to claim 12, wherein the at least one processing station of the equipping system is a labelling device.

18. The device according to claim 12, wherein the at least one processing station of the equipping system is a printing station and/or a printing head, and wherein the means for adapting comprises electronic means for at least one of compressing, rotating or stretching electronic artwork masters.

19. The method of claim 1, wherein equipping containers comprises applying printed images onto the containers, and wherein the at least one processing station of the equipping system is at least one printing station and/or a printing head, and wherein adapting the equipping process comprises at least one of electronically compressing, rotating or stretching electronic artwork masters.

20. The device according to claim 16, wherein the sensor unit is provided on one of a container intake and a transport star wheel.
